(19) United States
(12) Patent Application Publication
(10) Pub. No.: US 2025/0167254 A1
(43) Pub. Date: May 22, 2025

(54) FUEL CELLS HAVING HIGH CAPACITANCE ANODES FOR MITIGATING AIR-AIR START DEGRADATION

(71) Applicant: Robert Bosch GmbH, Stuttgart (DE)

(72) Inventors: Bjoern STUEHMEIER, Santa Clara, CA (US); Jonathan BRAATEN, Sunnyvale, CA (US); Lei CHENG, San Jose, CA (US); Nathan CRAIG, Sunnyvale, CA (US); Jake CHRISTENSEN, Elk Grove, CA (US)

(21) Appl. No.: 18/517,427

(22) Filed: Nov. 22, 2023

(51) Int. Cl. H01M 4/92; H01M 4/86; H01M 8/1004

(52) U.S. Cl. CPC H01M 4/926; H01M 4/921; H01M 4/923; H01M 4/925; H01M 8/1004; H01M 2004/8684

(57) ABSTRACT

A fuel cell (e.g., a proton exchange membrane fuel cell). The fuel cell includes a cathode electrode, an anode electrode having an anode catalyst layer, and a membrane extending between the cathode electrode and the anode electrode. The anode catalyst layer has a capacitance of greater than 0.1 F/cm² in a potential window for operation of the fuel cell of −0.1 to 1.2 V versus a reversible hydrogen potential. The capacitance of the anode catalyst layer mitigates degradation of the cathode electrode during an air-air start of the fuel cell.

### TECHNICAL FIELD

The present disclosure relates to fuel cells (e.g., proton exchange membrane fuel cells) having high capacitance anodes for mitigating air-air start degradation.

### BACKGROUND

One type of electrochemical cell is a device capable of generating electrical energy from chemical reactions (e.g., fuel cells). Fuel cells have shown promise as an alternative power source for vehicles and other transportation applications. Fuel cells operate with a renewable energy carrier, such as hydrogen. Fuel cells also operate without toxic emissions or greenhouse gases. An individual fuel cell includes a membrane electrode assembly (MEA) and two flow field plates. An individual fuel cell typically delivers 0.5 to 1.0 V. Individual fuel cells can be stacked together to form a fuel cell stack having higher voltage and power.

### SUMMARY

In one or more embodiments, a fuel cell (e.g., a proton exchange membrane fuel cell) having a high capacitance anode for mitigating air-air start degradation is disclosed. The fuel cell includes a cathode electrode, an anode electrode having an anode catalyst layer, and a membrane extending between the cathode electrode and the anode electrode. The anode catalyst layer has a capacitance of greater than 0.1 F/cm² in a potential window for operation of the fuel cell of −0.1 to 1.2 V versus a reversible hydrogen potential. The capacitance of the anode catalyst layer mitigates degradation of the cathode electrode during an air-air start of the fuel cell.

In another embodiment, a fuel cell (e.g., a proton exchange membrane fuel cell) having a high capacitance anode for mitigating air-air start degradation is disclosed. The fuel cell includes a cathode electrode, an anode electrode having an anode catalyst supported on an anode catalyst support having a support surface area of less than or equal to 500 m²/g, the anode catalyst is mixed with a carbon material having a carbon material surface area of greater than 500 m²/g at a mixing ratio, and a membrane extending between the cathode electrode and the anode electrode. The anode electrode may have a capacitance of greater than 0.1 F/cm² in a potential window for operation of the fuel cell of −0.1 to 1.2 V versus a reversible hydrogen potential. The capacitance of the anode electrode mitigates degradation of the cathode electrode during an air-air start of the fuel cell. The mixture may further include a non-carbon material having a capacitance of greater than 0.1 F/cm² and/or a carbon-containing composite material having a capacitance of greater than 0.1 F/cm² to form a mixture.

### BRIEF DESCRIPTION OF THE DRAWINGS

FIG. 1 is a schematic, side view of certain components of a prior art proton exchange membrane fuel cell (PEMFC).

FIG. 2 is a schematic, side view of the prior art PEMFC conceptually separated into a fuel cell segment and an electrolytic cell segment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. These terms may be used to modify any numeric value disclosed or claimed herein. Generally, the term “about” denoting a certain value is intended to denote a range within ±5% of the value. As one example, the phrase “about 100” denotes a range of 100±5, i.e., the range from 95 to 105. Generally, when the term “about” is used, it can be expected that similar results or effects according to the invention can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1 to 10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A”, the term also covers the possibility that B is absent, i.e., “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

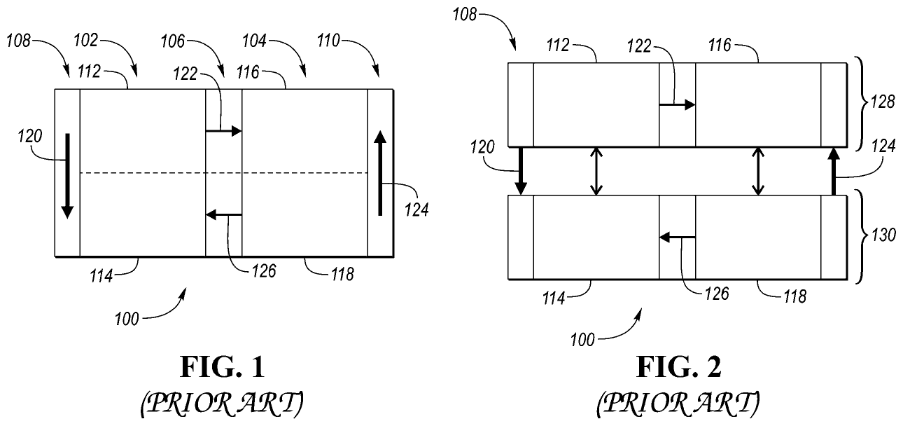

FIG. 1 is a schematic, side view of a certain components of a prior art proton exchange membrane fuel cell (PEMFC) 100. As shown in FIG. 1, fuel cell 100 includes anode compartment 102 including an anode catalyst support coated with an anode catalyst material and cathode compartment 104 including a cathode catalyst support coated with a cathode catalyst material. Polymer electrolyte material (PEM) 106 extends between anode compartment 102 and cathode compartment 104. Fuel cell 100 also includes first and second gas diffusion layers (GDLs) 108 and 110.

FIG. 1 is associated with a start-up and/or shut-down (SUSD) event in a PEMFC. During a SUSD event, a H₂/air front passes through an anode flow-field (including H₂-filled region 112 and air-filled region 114) while the cathode flow-field is filled with air with air-filled regions 116 and 118. During an SUSD event, the following hydrogen oxidation reaction (HOR) occurs in H₂-filled region 112 of anode compartment 102:

4H₂→4e⁻+4H⁺ (1)

During an SUSD event, the following oxygen reduction reaction (ORR) occurs in air-filled region 114 of anode compartment 102:

4H⁺+O₂+4e⁻→2H₂O (2)

The pathway of electrons through anode compartment 102 and first GDL 108 on the anode side is represented by arrow 120. As shown by arrow 122, protons pass through PEM 106 into cathode compartment 104.

During an SUSD event, the following oxygen reduction reaction (ORR) occurs in air-filled region 116 of cathode compartment 104:

4H⁺+O₂+4e⁻→2H₂O (3)

During an SUSD event, the following carbon corrosion reaction (COR) and oxygen evolution reaction (OER) occurs in air-filled region 118 of cathode compartment 104:

C+2H₂O→4e⁻+4H⁺+CO₂ (4)

2H₂O→4e⁻+4H⁺+O₂ (5)

The pathway of electrons through cathode compartment 104 and second GDL 110 on the cathode side is represented by arrow 124. As shown by arrow 126, protons pass through PEM 106 into anode compartment 106. In-plane proton conduction is only possible within very short distances from the H₂/air front (e.g., about 120 μm or less for a 20 μm thick membrane) and not over extended distances.

FIG. 2 is a schematic, side view of the prior art PEMFC 100 conceptually separated into fuel cell segment 128 and electrolytic cell segment 130. The hydrogen oxidation reaction (HOR) occurring in H₂-filled region 112 of fuel cell segment 128 may have a voltage reference of about 0.00 VRHE. The oxygen reduction reaction (ORR) occurring in air-filled region 116 of fuel cell segment 128 may have a voltage reference of about 0.84 VRHE. The oxygen reduction reaction (ORR) occurring in air-filled region 114 of electrolytic cell segment 130 may have a voltage reference of about 0.60 VRHE. The combined carbon corrosion reaction (COR) and oxygen evolution reaction (OER) occurring in air-filled region 118 of electrolytic cell segment 130 may have a voltage reference of about 1.44 VRHE. The AE between fuel cell segment 128 and electrolytic cell segment 130 may be about 0.6 V. The AE across the anode compartment 102 and cathode compartment 104 may be about 0.84 V.

An air-air start of a PEMFC may occur when the PEMFC is not used over an extended period of time (e.g., over a weekend or longer), thereby allowing air to infiltrate into the PEMFC. During an air-air start of a PEMFC, hydrogen gas is introduced to the air-filled anode compartment. This results in a polarization of both electrodes of the PEMFC in the flow direction, whereby carbon corrosion may occur in the cathode electrode. What is needed are devices and methods for mitigating cathode degradation during air-air start events.

The durability of a cathode catalyst layer in a PEMFC continues to be one of the main challenges for the widespread commercialization of PEMFCs for transportation and other applications. One of the main causes for degradation are air-air starts after extended shut-down periods. Under this scenario, a H₂/air gas front passes through the anode and causes a polarization of the anode between a hydrogen-filled anode segment, where the hydrogen oxidation reaction (HOR) takes place, and an air-filled anode segment, where the oxygen reduction reaction (ORR) occurs.

As these reactions occur within the same electrode with a high in-plane electrical conductivity and poor proton conductivity (e.g., insufficient for the in-plane conduction of protons over millimeter-scale distances), an oxidative current is forced on the segment of the cathode that is adjacent to the air-filled anode segment. This leads to a polarization of the cathode and cathode-sided carbon corrosion (COR) in the air-air filled segment of the cell. While system-based approaches have been developed to minimize start-up induced cathode degradation, catalyst material-based mitigation strategies are strongly desired to reduce system and operation costs.

In one or more embodiments, devices and methods for mitigating cathode degradation during air-air start events include an anode with a relatively high capacitance and use thereof. In one embodiment, a high capacitance anode may be achieved by using a relatively low Pt loading in a Pt/C anode catalyst material. In another embodiment, a high capacitance anode may be achieved by using a relatively high surface area anode carbon support made from a carbon support material. In yet another embodiment, a mixture of a Pt/C anode catalyst material and a relatively high surface area anode carbon support may be used to achieve a high capacitance anode. In other embodiments, a high capacitance anode may be achieved by adding a co-catalyst to the anode to serve as an electrochemical buffer. In one or more embodiments, two or more of the embodiments identified above may be combined.

In one or more embodiments, anode electrode compositions are disclosed. The anode electrode compositions as disclosed are configured to mitigate the polarization of the cathode during air-air start events, and therefore, mitigate overall cathode degradation.

The origin of the polarization referred to above is polarization of the anode from about 1 V in air to about 0 V in H₂ in combination with the limited proton conduction within the catalyst layers. As the time of the mixed gas composition is typically less than one (1) second and local currents within the catalyst layer are about 100 mA/cm², anodes with a high electrochemical capacity of greater than or equal to 0.1 F/cm² enable sufficiently high capacitive currents to mitigate the polarization of the cathode and thus resist, reduce or inhibit cathode corrosion.

Conventional anodes have a relatively low electrochemical capacity as low electrode loadings (e.g., 0.02 to 0.1 mgPt/cm²) are sufficient to obtain sufficient HOR activity. Relatively low surface area (and therefore relatively low double-layer capacity) supports are less susceptible to anode-side carbon corrosion during fuel starvation events and low surface area carbons require less ionomer and thus reduce manufacturing costs. However, the advantage of mitigating cathode degradation during unavoidable air-air starts as set forth in one or more embodiments herein offsets the disadvantages and/or costs of using high-capacitance anode compositions. The relatively high capacitance may be 0.1, 0.2, 0.3, 0.4, 0.5, 0.6, 0.7, 0.8, 0.9, 1, 2, 3, 4, 5, 6, 7, 8, 9, and 10 F/cm² in a relevant potential window for fuel cell operation (e.g., −0.1 to 1.2 V versus a reversible hydrogen potential).

For instance, a high capacitance in the anode electrode may be achieved by using a Pt/C or Pt-alloy/C catalyst at a relatively low Pt weight percentage to the total weight of the catalyst. The Pt loading may be any of the following values or in a range of any two of the following values: 1, 2, 3, 4, 5, 6, 7, 8, 9, and 10 weight percent. This relatively lower Pt catalyst loading achieves a higher double-layer capacity due to a higher carbon loading at the same Pt loading in mgPt/cm². The double-layer capacity may refer to a capacitance at the electrochemical interface between the anode electrode and an electrolyte in the PEMFC.

In another embodiment, a high capacitance in the anode electrode may be achieved by using a relatively high surface area carbon support as a support for a Pt or Pt-alloy based anode material. The surface area of the carbon support may be any of the following values or in a range of any two of the following values: 500, 1,000, 1,500, 2,000, 2,500, 3,000, 3,500, 4,000, 4,500, and 5,000 m²/g. The carbon support material may have a relatively high double-layer capacity.

In yet another embodiment, a high capacitance in the anode electrode may be achieved by using a relatively high capacitance non-carbon support material or a carbon-containing composite material as support for a Pt or Pt-alloy based anode catalyst. The high capacitance may be any of the following values or in a range of any two of the following values: 0.1, 0.2, 0.3, 0.4, 0.5, 0.6, 0.7, 0.8, 0.9, 1, 2, 3, 4, 5, 6, 7, 8, 9, and 10 F/cm².

As another example, a high capacitance in the anode electrode may be achieved by mixing a Pt- or Pt-alloy-based catalyst on a relatively low or medium surface area support material with a relatively high surface area carbon material, a high capacitance non-carbon material, and/or a high capacitance carbon-containing composite material. The relatively low or medium surface area of the support material may be any of the following values or in a range of any two of the following values: 50, 100, 150, 200, 250, 300, 350, 400, 450, and 500 m²/g. The relatively high surface area of the carbon material or the high capacitance non-carbon material may be any of the following values or in a range of any two of the following values: 500, 1,000, 1,500, 2,000, 2,500, 3,000, 3,500, 4,000, 4,500, and 5,000 m²/g. The ratio of the relatively low or medium surface area support material to the relatively high surface area carbon material or a high capacitance non-carbon material may be in the range of 1:1 to 1:4. In one or more embodiments, the high capacitance anode electrode may include substantially all of the carbon material support. In one or more embodiments, an anode is disclosed that uses a mixture of a high surface area and a low surface area carbon support material with controlled directional pore structure. The low surface area carbon may be decorated by high surface area carbon for high capacitance. In one or more embodiments, a high capacitance additive (e.g., graphene or graphene oxide nano-plates) may be used.

The high capacitance non-carbon material may be a chemically stable metal oxide (e.g., zirconium oxide, titanium oxide, lanthanum oxide, barium oxide, tungsten oxide, niobium oxide, tantalum oxide, or a combination thereof), a metal nitride (e.g., titanium nitride, niobium nitride, zirconium nitride, tantalum nitride, tungsten nitride, or a combination thereof) or a metal carbide (e.g., titanium carbide, niobium carbide, tungsten carbide, or combination thereof), or combination thereof. The high capacitance non-carbon material may be nano-based particles.

In another embodiment, a co-catalyst may be added to achieve a high capacitance in the anode electrode by mixing or other incorporation method. The co-catalyst may be configured to undergo a reversible reduction/oxidation reaction in a relevant potential between −0.1 V and 1.2 V leading to a pseudo-capacitance. The pseudo-capacitance may be any of the following values or in a range of any two of the following values: 0.1, 0.2, 0.3, 0.4, 0.5, 0.6, 0.7, 0.8, 0.9, 1, 2, 3, 4, 5, 6, 7, 8, 9, and 10 F/cm². Non-limiting examples of co-catalysts include functionalized carbon nano tubes, redox active polymers, reduced graphene oxide, and combinations thereof. Co-catalyst materials may also include other materials typically found in redox capacitors and/or supercapacitors that are stable under fuel cell operating conditions.

In yet another embodiment, a proton insertion material may be added to achieve a high capacitance in the anode electrode by mixing or other incorporation method. The proton insert material may have a charge/discharge potential between −0.1 V and 1.2 V. The proton insertion material may have the following capacitance or pseudo-capacitance or in a range of the following capacitance or pseudo-capacitance: 0.1, 0.2, 0.3, 0.4, 0.5, 0.6, 0.7, 0.8, 0.9, 1, 2, 3, 4, 5, 6, 7, 8, 9, and 10 F/cm². The proton insertion material may have the following capacitance or pseudo-capacitance or in a range of the following capacitance or pseudo-capacitance: 0.03, 0.1, 0.2, 0.3, 0.4, 0.5, 0.6, 0.7, 0.8, 0.9, 1, 2, and 3 mAh/cm². The effective particle size of the proton insertion material may be any of the following values or in a range of any two of the following values: 50 nm, 100 nm, 200 nm, 300 nm, 400 nm, 500 nm, 600 nm, 700 nm, 800 nm, 900 nm, and 1 μ. The proton insertion material may be Pd metal, TiO₂, or a combination thereof.

In one or more embodiments, two or more of the embodiments identified above may be combined. For instance, the co-catalyst may be added to a Pt/C or Pt-alloy catalyst (e.g., with a catalyst support) at a relatively low Pt weight percentage to the total weight of the catalyst and/or a relatively high surface area carbon support as a support for a Pt or Pt-alloy based anode material.

While exemplary embodiments are described above with respect to PEMFCs, it is not intended that these embodiments describe all possible forms encompassed by the claims. For example, one or more embodiments of the high capacitance anodes disclosed herein may be applied to phosphoric acid fuel cells and/or electrochemical hydrogen pumps. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell comprising:
a cathode electrode;
an anode electrode having an anode catalyst layer; and
a membrane extending between the cathode electrode and the anode electrode, the anode catalyst layer having a capacitance of greater than 0.1 F/cm² in a potential window for operation of the fuel cell of −0.1 to 1.2 V versus a reversible hydrogen potential, the capacitance of the anode catalyst layer mitigates degradation of the cathode electrode during an air-air start of the fuel cell.

2. The fuel cell of claim 1, wherein the anode catalyst layer includes a platinum (Pt) weight percent of less than or equal to 10 weight percent.

3. The fuel cell of claim 2, wherein the anode catalyst layer includes a Pt/carbon (C) catalyst material, a Pt-alloy/C catalyst material, or a combination thereof.

4. The fuel cell of claim 1, wherein the anode electrode includes a carbon support material having a surface area of greater than 500 m²/g.

5. The fuel cell of claim 1, wherein the anode electrode includes a support material configured to support an anode catalyst material, the support material includes a non-carbon support material, a carbon-containing composite material, or a combination thereof, the support material having a capacitance of greater than 0.1 F/cm².

6. The fuel cell of claim 5, wherein the non-carbon support material is formed of nano-based particles of a metal oxide, a metal nitride, a metal carbide, or a combination thereof.

7. The fuel cell of claim 1, wherein the anode electrode incorporates a co-catalyst having a reversible reduction/oxidation potential between −0.1 and 1.2 V and a capacitance or pseudo-capacitance of greater than 0.1 F/cm².

8. The fuel cell of claim 1, wherein the anode electrode incorporates a proton insertion material having a charge/discharge potential between −0.1 and 1.2 V and a capacitance or pseudo-capacitance of greater than 0.1 F/cm² or 0.03 mAh/cm².

9. The fuel cell of claim 8, wherein the proton insertion material has an effective particle diameter of less than 1 μm.

10. A fuel cell comprising:
a cathode electrode;
an anode electrode having an anode catalyst supported on an anode catalyst support having a support surface area of less than or equal to 500 m²/g, the anode catalyst is mixed with a carbon material having a carbon material surface area of greater than 500 m²/g at a mixing ratio, a non-carbon material having a capacitance of greater than 0.1 F/cm², and/or a carbon-containing composite material having a capacitance of greater than 0.1 F/cm² to form a mixture; and
a membrane extending between the cathode electrode and the anode electrode, the anode electrode having a capacitance of greater than 0.1 F/cm² in a potential window for operation of the fuel cell of −0.1 to 1.2 V versus a reversible hydrogen potential, the capacitance of the anode electrode mitigates degradation of the cathode electrode during an air-air start of the fuel cell.

11. The fuel cell of claim 10, wherein the mixing ratio is 1:1 to 1:4.

12. The fuel cell of claim 10, wherein the mixture includes directional pore structures.

13. The fuel cell of claim 10, wherein the anode catalyst support is decorated by the carbon material.

14. The fuel cell of claim 10, wherein the non-carbon material is formed of nano-based particles of a metal oxide, a metal nitride, a metal carbide, or a combination thereof.

15. The fuel cell of claim 14, wherein the metal oxide includes zirconium oxide, titanium oxide, lanthanum oxide, barium oxide, tungsten oxide, niobium oxide, tantalum oxide, or a combination thereof.

16. The fuel cell of claim 14, wherein the metal nitride includes titanium nitride, niobium nitride, zirconium nitride, tantalum nitride, tungsten nitride, or a combination thereof.

17. The fuel cell of claim 14, wherein the metal carbide includes titanium carbide, niobium carbide, tungsten carbide, or a combination thereof.

18. The fuel cell of claim 10, wherein the carbon material includes graphene nano-plates, graphene oxide nano-plates, or a combination thereof.

19. A fuel cell comprising:
a cathode electrode;
an anode electrode having an anode catalyst supported on an anode catalyst support having a support surface area of less than or equal to 500 m²/g, the anode catalyst is mixed with a carbon material having a carbon material surface area of greater than 500 m²/g at a mixing ratio; and
a membrane extending between the cathode electrode and the anode electrode, the anode electrode having a capacitance of greater than 0.1 F/cm² in a potential window for operation of the fuel cell of −0.1 to 1.2 V versus a reversible hydrogen potential, the capacitance of the anode electrode mitigates degradation of the cathode electrode during an air-air start of the fuel cell.

20. The fuel cell of claim 19, wherein the carbon material includes graphene nano-plates, graphene oxide nano-plates, or a combination thereof.
